(19) United States
(12) Patent Application Publication
(10) Pub. No.: US 2017/0307170 A1
(43) Pub. Date: Oct. 26, 2017

(54) APPARATUS FOR PRODUCING LIGHT HAVING THREE-DIMENSIONAL LIGHTING EFFECT

(71) Applicant: The Gerson Company, Olathe, KS (US)

(72) Inventors: Lynda Scott Musante, Olathe, KS (US); Liwei Huang, Shenzhen (US)

(21) Appl. No.: 15/241,695

(22) Filed: Aug. 19, 2016

(30) Foreign Application Priority Data
Apr. 25, 2016 (CN) 201620350589.2

(51) Int. Cl. F21V 5/00; F21S 10/04; F21S 13/12; F21V 3/00; F21V 7/00; F21W 121/00

(52) U.S. Cl. CPC F21V 5/00; F21V 3/00; F21V 7/0066; F21S 10/04; F21S 13/12; F21W 2121/00

(57) ABSTRACT

An apparatus for producing light having a three-dimensional lighting effect. The apparatus includes a light source, a cover, an inner opaque reflecting layer, and an outer refracting layer. The cover has first light transmittance value. The opaque reflecting layer is applied to an inner surface of the cover. The outer refracting layer is applied to an outer surface of the cover, and has a second light transmittance value which is less than that of the cover. A pattern is added between the inner and outer layers. In operation, a first portion of the light emitted by the light source passes through the inner layer, the cover, and the outer layer, and a second portion of the light bounces between the outer refracting layer and the opaque reflecting layer before passing through the outer refracting layer. Additionally, an interior refracting layer may be used to spread the light more widely and evenly onto the opaque reflecting layer.

### RELATED APPLICATION

The present U.S. patent application is related to and claims priority benefit with regard to all common subject matter of an earlier-filed and co-pending Chinese patent application titled “A DECORATIVE LED CANDLE WITH 3 DIMENSIONAL EFFECT”, Chinese Application No. 201620350589.2, filed Apr. 25, 2016. The entire content of the identified earlier-filed Chinese patent application is hereby incorporated by reference into the present application as if fully set forth herein.

### FIELD

The present invention relates to apparatuses for producing light, and more particularly, to an apparatus for producing light having a three-dimensional lighting effect.

### BACKGROUND

It is sometimes desirable to produce light having a three-dimensional lighting effect for utilitarian or decorative purposes. Prior attempts to produce light having such an effect suffer from several limitations. For example, the addition of a painted or plated Mercury Glass effect on glass is attractive and used to diffuse light. The mercury glass effect appears to be random, but generally looks the same on any surface to which it is applied. The glass can be painted to add a coloured effect. However, mercury glass results only in a one-dimensional overall effect.

This background discussion is intended to provide information related to the present invention which is not necessarily prior art.

### SUMMARY

Embodiments of the present invention provide an apparatus for producing light having a three-dimensional lighting effect. More specifically, embodiments provide a “Galaxy Effect” through a multi-step process in which a glass shape is provided with various layers to achieve a three-dimensional overall effect.

In one embodiment, the apparatus may broadly comprise a light source, a cover, an inner opaque reflecting layer, and an outer refracting layer. The light source may emit light. The cover may be spaced apart from and at least partially surround the light source and may be constructed of an at least partially transparent material having a first light transmittance value, and the cover may have an inner surface and an outer surface. The inner opaque reflecting layer may be positioned between the light source and the cover. The outer refracting layer may be associated with the outer surface of the cover and have a second light transmittance value which is less than the first transmittance value of the cover. A pattern may be located between the inner and outer layers. In operation, a first portion of the light emitted by the light source may pass through the cover and through the outer refracting layer, and a second portion of the light may bounce between the outer refracting layer and the inner opaque reflecting layer before passing through the outer refracting layer, thereby imparting the three-dimensional lighting effect to the light.

Various implementations of the foregoing embodiment may include any one or more of the following additional features. The light source may be an electric light source or may be a real flame. The light source may emit the light with or without a flickering effect. The cover may have a three-dimensional shape, such as a cylindrical or spherical shape or a representational shape that represents a decorative object such as a Christmas tree or angel. The inner opaque reflecting layer may be applied to the inner surface of the cover. The apparatus may further include an interior refracting layer positioned between the light source and the inner opaque reflecting layer and configured to spread the light more widely and evenly onto the inner opaque reflecting layer. The interior refracting layer may be applied to an inner surface of the inner opaque reflecting layer, and may be constructed of wax or paint. The apparatus may further include a color layer of transparent color to impart a color effect to the light.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a cross-sectional elevation view of an apparatus constructed in accordance with an embodiment of the present invention;

FIG. 2 is a cross-sectional fragmentary view of a cylindrically-shaped cover component of the apparatus of FIG. 1; and

FIG. 3 is a cross-sectional cut-away view of the apparatus of FIG. 1 having a spherically-shaped cover component.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

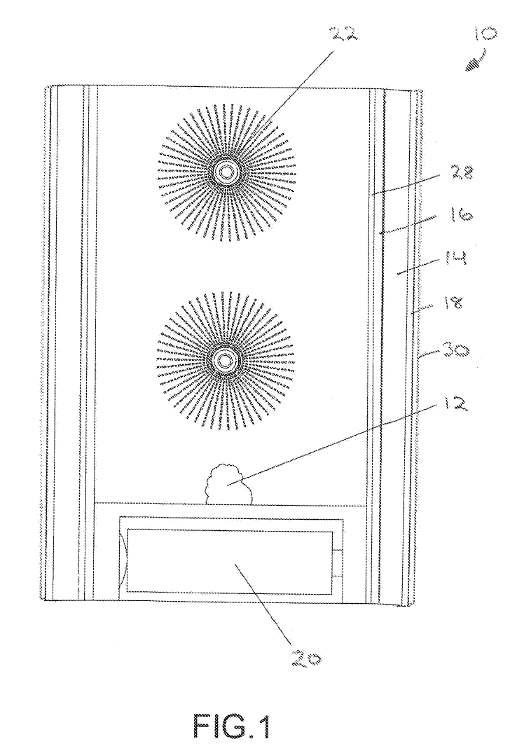

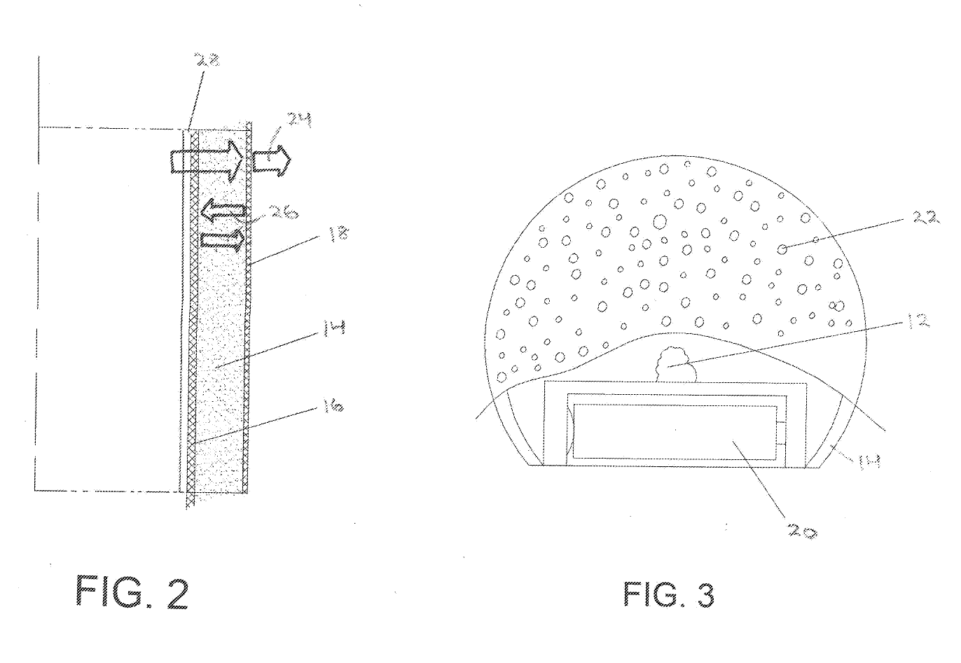

Broadly characterized, embodiments of the present invention provide an apparatus for producing light having a three-dimensional lighting effect. More specifically, embodiments provide a “Galaxy Effect” through a multi-step process in which a glass shape is provided with various layers to achieve a three-dimensional overall effect. In one embodiment, shown in FIG. 1, the apparatus 10 may broadly include a light source 12; a cover 14; an inner opaque reflecting layer 16; and an outer refracting layer 18. The apparatus 10 may take the general form of a utilitarian or decorative object, such as, e.g., an electric candle or lantern, a lamp, or a holiday or other decoration.

The light source 12 may be configured to emit light of one or more or a range of wavelengths. The light source 12 may be an electric light source, and may include one or more light emitting diodes. The one or more light emitting diodes may be configured to emit different colours of light during operation, and the change from one colour to another may occur randomly or non-randomly. Additionally or alternatively, the electric light source may be configured to cause the emitted light to flicker, such as a real flame might flicker. A power source 20, such as a battery or power cord, may provide power to the electric light source. Alternatively, the light source 12 may be a real flame.

The cover 14 may be spaced apart from and at least partially surround the light source 12. The cover 14 may be constructed of substantially any suitable transparent or semi-transparent material, such as glass or transparent or semi-transparent plastic, and may have substantially any suitable shape, such a cylindrical (as seen in FIG. 1), spherical (as seen in FIG. 3), or other geometrical, random, or representative shape, and may have an inner surface and an outer surface. For some applications, the cover 14 may have a representational shape of a decorative object such as a Christmas tree or angel. The cover 14 may have a light transmittance property having a first light transmittance value.

The inner opaque reflecting layer 16 may be applied to, adjacent to, or otherwise associated with the inner surface of the cover 14 (i.e., a surface closer to the light source 12).

The outer refracting layer 18 may be associated with the outer surface of the cover 14 (i.e., a surface farther from the light source 12 and opposite the inner surface associated with the inner opaque reflecting layer 16). The outer refracting layer 18 may have a light transmittance property having a second light transmittance value which is lower than the first light transmittance value of the cover 14 so that a first portion 24 of the light passing through the cover 14 passes outwardly through the outer refracting layer 18, and a second portion 26 of the light is reflected by the outer refracting layer 16 back inwardly through the cover 14 and toward the inner opaque reflecting layer 18 which reflects it outwardly again. Thus, the second portion 26 of the light bounces between the outer refracting layer 18 and the inner opaque reflecting layer 16 until it ultimately passes through the outer refracting layer 18.

A pattern 22 may be added between the inner and outer layers 16,18 and which at least partially blocks and partially passes the emitted light. The pattern 22 may be substantially any suitable pattern, such as a geometrical, random, or representative pattern, and may be constructed using substantially any suitable process, such as laser or chemical etching, or with substantially any suitable opaque or semi-transparent material, such as paint.

Additionally, the apparatus may include an interior refracting layer 28 applied to, adjacent to, or otherwise associated with an inner surface of the inner opaque reflecting layer 18 (i.e., a surface closer to the light source 12). The interior refracting layer 28 may be configured to spread the light more widely and evenly onto the inner opaque reflecting layer 18. The interior refracting layer 28 may be constructed of wax, paint, or a similarly suitable material or combination of materials, which, as mentioned, may be applied to the inner surface of the inner opaque reflecting layer 18.

Additionally, a color layer 30 of transparent color may be added to the apparatus 10 to impart a color effect to the light and thereby enhance the overall impact. The color layer 30 may be added to substantially any suitable surface within the apparatus 10, such as over the outer reflecting layer 18.

In operation, the light emitted by the light source 12 may pass through the interior refracting layer 28, which spreads the light more widely and evenly onto the inner opaque reflecting layer 16; passes through the inner opaque reflecting layer 16, except where the pattern 22 may block it; passes through the cover 14; and then the first portion 24 of the light passes through the outer refracting layer 18, and because the light transmittance value of the outer refracting layer 18 is lower than that of the cover 14, the second portion 26 of the light bounces between the outer refracting layer 18 and the inner opaque reflecting layer 16 to impart a three-dimensional effect to the light cast by the apparatus 10.

In more detail, the pattern 22 results in flare shapes on the outer refracting layer 18. A portion of the flare passes through the outer refracting layer 18, while another portion of the flare bounces repeatedly between the outer refracting layer 18 and the inner opaque reflecting layer 16 to impart a three-dimensional effect to the light pattern cast by the apparatus 10.

Further, the flickering of the emitted light may provide an additional motional effect to the light cast by the apparatus 10.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. An apparatus for producing light having a three-dimensional lighting effect, the apparatus comprising:
a light source emitting a light;
a cover spaced apart from and at least partially surrounding the light source and constructed of an at least partially transparent material having a first light transmittance value, and the cover having an inner surface and an outer surface;
an inner opaque reflecting layer positioned between the light source and the cover;
an outer refracting layer associated with the outer surface of the cover and having a second light transmittance value which is less than the first transmittance value of the cover; and
a pattern located between the inner opaque reflecting layer and the outer refracting layer, and which partially blocks and partially passes the emitted light,
such that a first portion of the light emitted by the light source passes through the cover and through the outer refracting layer, and a second portion of the light bounces between the outer refracting layer and the inner opaque reflecting layer before passing through the outer refracting layer, thereby imparting the three-dimensional lighting effect to the light.

2. The apparatus as set forth in claim 1, wherein the light source is an electric light source.

3. The apparatus as set forth in claim 1, wherein the light source is a real flame.

4. The apparatus as set forth in claim 1, wherein the light source emits the light with a flickering effect.

5. The apparatus as set forth in claim 1, wherein the cover has a geometric shape.

6. The apparatus as set forth in claim 1, wherein the cover has a representational shape.

7. The apparatus as set forth in claim 1, wherein the inner opaque reflecting layer is applied to the inner surface of the cover.

8. The apparatus as set forth in claim 1, further including an interior refracting layer positioned between the light source and the inner opaque reflecting layer and configured to spread the light more widely and evenly on the inner opaque reflecting layer.

9. The apparatus as set forth in claim 8, wherein the interior refracting layer is applied to an inner surface of the inner opaque reflecting layer.

10. The apparatus as set forth in 9, wherein the interior refracting layer is constructed of wax.

11. The apparatus as set forth in 9, wherein the interior refracting layer is constructed of paint.

12. An apparatus for producing light having a three-dimensional lighting effect, the apparatus comprising:
an electric light source emitting a light;
a cover spaced apart from and at least partially surrounding the electric light source and constructed of an at least partially transparent material having a first light transmittance value, and the cover having an inner surface and an outer surface;
an inner opaque reflecting layer applied to the inner surface of the cover;
an outer refracting layer applied to the outer surface of the cover and having a second light transmittance value which is less than the first transmittance value of the cover
a pattern located between the inner opaque reflecting layer and the outer refracting layer, and which partially blocks and partially passes the emitted light,
such that a first portion of the light emitted by the electric light source passes through the cover and through the outer refracting layer, and a second portion of the light bounces between the outer refracting layer and the inner opaque reflecting layer before passing through the outer refracting layer, thereby imparting the three-dimensional lighting effect to the light.

13. The apparatus as set forth in claim 12, wherein the light source emits the light with a flickering effect.

14. The apparatus as set forth in claim 12, wherein the cover has a geometric shape.

15. The apparatus as set forth in claim 12, wherein the cover has a representational shape.

16. The apparatus as set forth in claim 12, further including an interior refracting layer positioned between the light source and the inner opaque reflecting layer and configured to spread the light more widely and evenly on the inner opaque reflecting layer.

17. The apparatus as set forth in 16, wherein the interior refracting layer is constructed of wax.

18. The apparatus as set forth in 16, wherein the interior refracting layer is constructed of paint.

19. An apparatus for producing light having a three-dimensional lighting effect, the apparatus comprising:
an electric light source emitting a light having a flickering effect;
a cover spaced apart from and at least partially surrounding the electric light source and constructed of an at least partially transparent material having a first light transmittance value, and the cover having an inner surface and an outer surface;
an inner opaque reflecting layer applied to the inner surface of the cover;
an interior refracting layer applied to an inner surface of the inner opaque reflecting layer to spread the emitted light more widely and evenly onto the inner opaque reflecting layer;
an outer refracting layer applied to the outer surface of the cover and having a second light transmittance value which is less than the first transmittance value of the cover
a pattern located between the inner opaque reflecting layer and the outer refracting layer, and which partially blocks and partially passes the emitted light,
such that a first portion of the light emitted by the electric light source passes through the cover and through the outer refracting layer, and a second portion of the light bounces between the outer refracting layer and the inner opaque reflecting layer before passing through the outer refracting layer, thereby imparting the three-dimensional lighting effect to the light.

20. The apparatus as set forth in claim 19, further including a color layer of transparent color to impart a color effect to the light.
